(19) United States
(12) Patent Application Publication
(10) Pub. No.: US 2025/0336611 A1
(43) Pub. Date: Oct. 30, 2025

(54) MULTILAYER CERAMIC CAPACITOR

(71) Applicant: Murata Manufacturing Co., Ltd., Nagaokakyo-shi, Kyoto-fu (JP)

(72) Inventors: Yukihiro FUJITA, Nagaokakyo-shi (JP); Seiji HIDAKA, Nagaokakyo-shi (JP)

(21) Appl. No.: 19/262,565

(22) Filed: Jul. 8, 2025

Related U.S. Application Data
(63) Continuation of application No. PCT/JP2024/017777, filed on May 14, 2024.

(30) Foreign Application Priority Data
Jun. 7, 2023 (JP) 2023-093699

(51) Int. Cl. H01G 4/30; H01G 4/012; H01G 4/232

(52) U.S. Cl. CPC H01G 4/30; H01G 4/012; H01G 4/232

(57) ABSTRACT

In a multilayer ceramic capacitor, each of multiple first inner electrode layers includes multiple first inner electrode portions mutually separated in a same layer. Each of multiple second inner electrode layers is defined by one body in a same layer. Each of the multiple first inner electrode portions is electrically connected to corresponding multiple first via conductors. Each of multiple first outer electrodes is electrically connected to multiple first via conductors electrically connected to a corresponding first inner electrode portion of the multiple first inner electrode portions. At least one second outer electrode is electrically connected to corresponding multiple second via conductors.

### CROSS REFERENCE TO RELATED APPLICATIONS

This application claims the benefit of priority to Japanese Patent Application No. 2023-093699 filed on Jun. 7, 2023 and is a Continuation application of PCT Application No. PCT/JP2024/017777 filed on May 14, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Prior art documents disclosing a configuration of an electronic component to be embedded in a wiring board include Japanese Unexamined Patent Application Publication No. 2009-295687. The electronic component to be embedded in a wiring board described in Japanese Unexamined Patent Application Publication No. 2009-295687 includes a ceramic sintered body and an outer electrode. The ceramic sintered body includes a main surface and a back surface. The outer electrode is disposed on at least one of the main surface and the back surface of the ceramic sintered body and is formed by forming a copper plating layer on a surface of a metalized layer. In the ceramic sintered body, multiple inner electrodes are disposed in a laminating manner with a ceramic dielectric layer interposed therebetween, and multiple intra-capacitor via conductors connected to the multiple inner electrodes are provided. The outer electrode is connected to end portions, of multiple intra-capacitor via conductors, on at least one side of the main surface side and the back surface side. The multiple intra-capacitor via conductors are arranged in an array as a whole.

### SUMMARY OF THE INVENTION

Example embodiments of the present invention provide high-capacitance-density multilayer ceramic capacitors, in each of which, multiple capacitor function portions connectable to power sources different in electric potential are densely arranged side by side.

A multilayer ceramic capacitor according to an example embodiment of the present invention includes a capacitor main body, multiple first via conductors, multiple second via conductors, multiple first outer electrodes, and at least one second outer electrode. The capacitor main body includes multiple first inner electrode layers and multiple second inner electrode layers that are alternately laminated one by one across a dielectric layer in a lamination direction, and the capacitor main body includes a first main surface and a second main surface positioned opposite from the first main surface in the lamination direction. The multiple first via conductors are provided inside the capacitor main body and electrically connected to the multiple first inner electrode layers. The multiple second via conductors are provided inside the capacitor main body and electrically connected to the multiple second inner electrode layers. The multiple first outer electrodes and the at least one second outer electrode are mutually spaced on the first main surface. Each of the multiple first inner electrode layers includes multiple first inner electrode portions mutually separated in the same layer. Each of the multiple second inner electrode layers is defined by one body in a same layer. Each of the multiple first inner electrode portions is electrically connected to corresponding multiple first via conductors of the multiple first via conductors. Each of the multiple first outer electrodes is electrically connected to multiple first via conductors electrically connected to a corresponding first inner electrode portion of the multiple first inner electrode portions. The at least one second outer electrode is electrically connected to corresponding multiple second via conductors of the multiple second via conductors.

According to example embodiments of the present invention, high-capacitance-density multilayer ceramic capacitors in which multiple capacitor function portions connectable to power sources different in electric potential are densely arranged side by side are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic capacitor according to a first example embodiment of the present invention when viewed from the first main surface side.

FIG. 2 is a plan view of the multilayer ceramic capacitor in FIG. 1 when viewed in the II direction.

FIG. 3 is a sectional view of the multilayer ceramic capacitor in FIG. 2 when viewed from the direction of III-III line arrows.

FIG. 4 is a plan view of a capacitor main body.

FIG. 5 is a sectional view of the multilayer ceramic capacitor in FIG. 3 when viewed from the direction of V-V line arrows.

FIG. 6 is a sectional view of the multilayer ceramic capacitor in FIG. 3 when viewed from the direction of VI-VI line arrows.

FIG. 7 is a plan view of a multilayer ceramic capacitor according to a first modification example of the first example embodiment of the present invention.

FIG. 8 is a side view of the multilayer ceramic capacitor in FIG. 7 when viewed in the VIII arrow direction.

FIG. 9 is a side view of the multilayer ceramic capacitor in FIG. 7 when viewed in the IX arrow direction.

FIG. 10 is a perspective view of a multilayer ceramic capacitor according to a second modification example of the first example embodiment of the present invention when viewed from the second main surface side.

FIG. 11 is a sectional view of the multilayer ceramic capacitor in FIG. 10 when viewed from the direction of XI-XI line arrows.

FIG. 12 is a perspective view of a multilayer ceramic capacitor according to a third modification example of the first example embodiment of the present invention when viewed from the second main surface side.

FIG. 13 is a sectional view of the multilayer ceramic capacitor in FIG. 12 when viewed from the direction of XIII-XIII line arrows.

FIG. 14 is a sectional view of the multilayer ceramic capacitor in FIG. 12 when viewed from the direction of XIV-XIV line arrows.

FIG. 15 is a perspective view of a multilayer ceramic capacitor according to a second example embodiment of the present invention when viewed from the first main surface side.

FIG. 16 is an exploded perspective view illustrating the configuration of the multilayer ceramic capacitor according to the second example embodiment of the present invention.

FIG. 17 is a perspective view of the multilayer ceramic capacitor in FIG. 16 when viewed in the XVII direction.

FIG. 18 is a sectional view of the multilayer ceramic capacitor in FIG. 17 when viewed from the direction of XVIII-XVIII line arrows.

FIG. 19 is a sectional view of the multilayer ceramic capacitor in FIG. 17 when viewed from the direction of XIX-XIX line arrows.

FIG. 20 is a sectional view of the multilayer ceramic capacitor in FIG. 17 when viewed from the direction of XX-XX line arrows.

### DETAILED DESCRIPTION OF THE EXAMPLE EMBODIMENTS

Hereinafter, a multilayer ceramic capacitor according to each of example embodiments of the present invention will be described with reference to the drawings. Note that, in the description of the following example embodiments, the same or equivalent portions in the drawings are denoted by the same reference signs, and the description thereof will not be repeated.

### First Example Embodiment

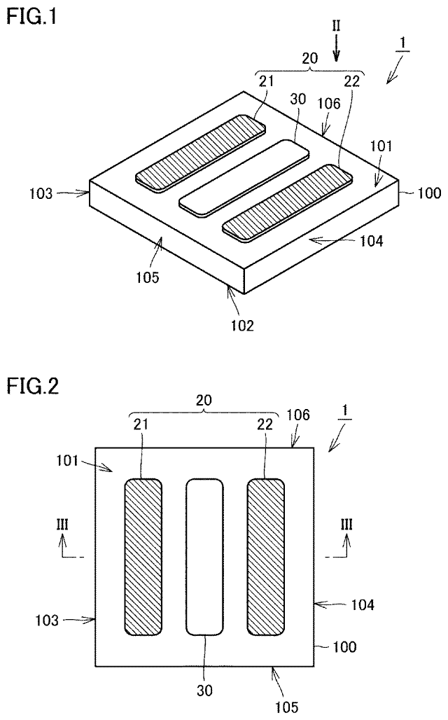

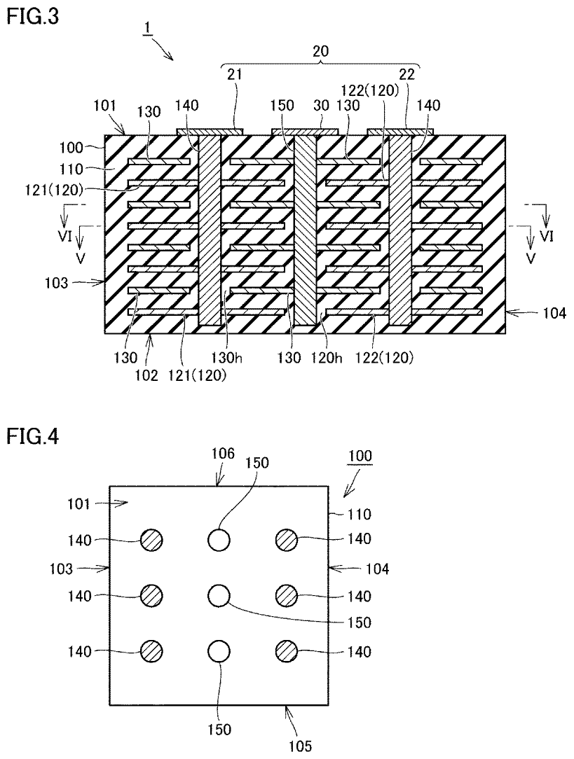

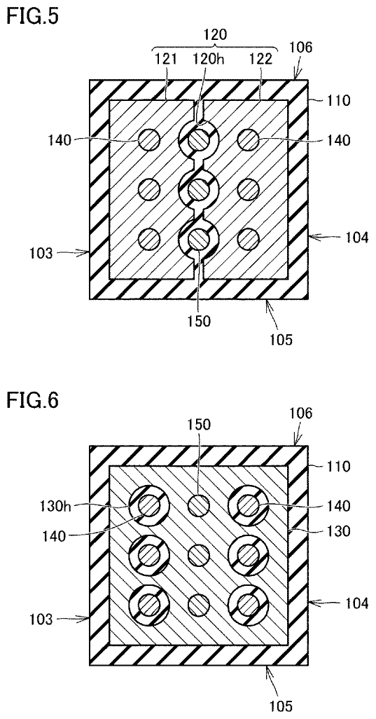

FIG. 1 is a perspective view of a multilayer ceramic capacitor according to a first example embodiment of the present invention when viewed from the first main surface side. FIG. 2 is a plan view of the multilayer ceramic capacitor in FIG. 1 when viewed in the II direction. FIG. 3 is a sectional view of the multilayer ceramic capacitor in FIG. 2 when viewed from the direction of III-III line arrows. FIG. 4 is a plan view of a capacitor main body. FIG. 5 is a sectional view of the multilayer ceramic capacitor in FIG. 3 when viewed from the direction of V-V line arrows. FIG. 6 is a sectional view of the multilayer ceramic capacitor in FIG. 3 when viewed from the direction of VI-VI line arrows.

As FIGS. 1 to 6 illustrate, a multilayer ceramic capacitor 1 according to the first example embodiment of the present invention includes a capacitor main body 100, multiple first via conductors 140, multiple second via conductors 150, multiple first outer electrodes 20, and at least one second outer electrode 30.

As FIG. 3 illustrates, the capacitor main body 100 includes multiple first inner electrode layers 120 and multiple second inner electrode layers 130 that are alternately laminated one by one across a dielectric layer 110 in a lamination direction, and the capacitor main body 100 includes a first main surface 101 and a second main surface 102 positioned opposite from the first main surface 101 in the lamination direction.

The material of the dielectric layer 110 is any material and may be, for example, a ceramic material including, for example, BaTiO₃, CaTiO₃, SrTiO₃, SrZrO₃, or CaZrO₃ as a main component. Each of such main components may be added with a sub-component that includes one of a Mn compound, an Fe compound, a Cr compound, a Co compound, or a Ni compound and has smaller content than the main component.

The capacitor main body 100 may have any shape. In the present example embodiment, the capacitor main body 100 has an overall rectangular parallelepiped shape. Such an overall rectangular parallelepiped shape is a shape that includes six surfaces and can be viewed as a rectangular parallelepiped as a whole although the shape is not a perfect rectangular parallelepiped shape such as a shape of a rectangular parallelepiped with rounded corner portion and ridge portion. Thus, the capacitor main body 100 includes the first main surface 101, the second main surface 102, a first side surface 103, a second side surface 104, a third side surface 105, and a fourth side surface 106.

The first to fourth side surfaces 103 to 106 of the capacitor main body 100 define, in the surfaces of the capacitor main body 100, four side surfaces that are surfaces other than the first main surface 101 and the second main surface 102. That is, the capacitor main body 100 further includes the first to fourth side surfaces 103 to 106 that are the four side surfaces connecting the first main surface 101 and the second main surface 102 to each other. The first side surface 103 faces the second side surface 104, and the third side surface 105 faces the fourth side surface 106. In the present example embodiment, the first to fourth side surfaces 103 to 106 of the capacitor main body 100 are orthogonal to each of the first main surface 101 and the second main surface 102 but are not necessarily orthogonal thereto.

Although the capacitor main body 100 may have any dimensions, for example, in a rectangular or substantially rectangular shape when viewed from the first main surface 101 side, the vertical dimension may be about 0.3 mm or more and about 3.0 mm or less, the lateral dimension may be about 0.3 mm or more and about 3.0 mm or less, and the dimension of the dielectric layers 110, the first inner electrode layers 120, and the second inner electrode layers 130 in the lamination direction may be about 50 μm or more and about 200 μm or less, for example. Such a dimension of the capacitor main body 100 in the lamination direction is a thickness of the capacitor main body 100.

As FIGS. 3 and 5 illustrate, each of the multiple first inner electrode layers 120 includes multiple first inner electrode portions mutually separated in the same layer. In the present example embodiment, each of the multiple first inner electrode layers 120 includes a first inner electrode portion 121 and a first inner electrode portion 122 mutually separated in the same layer. The first inner electrode portion 121 and the first inner electrode portion 122 have shapes that are line-symmetrical to each other. However, the shapes of the first inner electrode portion 121 and the first inner electrode portion 122 are not limited to such line-symmetrical shapes and may be shapes that are asymmetrical to each other. In addition, the number of the first inner electrode portions disposed in the same layer is not limited to two and may be three or more. Each of the multiple first inner electrode layers 120 includes multiple first through holes 120h for insertion of the multiple second via conductors 150, which will be described later.

As FIGS. 3 and 6 illustrate, each of the multiple second inner electrode layers 130 is defined by one body in the same layer. The second inner electrode layer 130 has a rectangular or substantially rectangular outside shape substantially identical to the first inner electrode layer 120. Each of the multiple second inner electrode layers 130 has multiple second through holes 130h for insertion of the multiple first via conductors 140, which will be described later.

The materials of the first inner electrode layer 120 and the second inner electrode layer 130 are each any material and may include, as a main component, for example, a metal such as Ni, Cu, Ag, Pd, Pt, Fe, Ti, Cr, Sn, or Au or an alloy including such an above-described metal. The first inner electrode layer 120 and the second inner electrode layer 130 may include, as a common component, the same ceramic material as a dielectric ceramic included in the dielectric layer 110. In that case, the proportion of the common material included in each of the first inner electrode layer 120 and the second inner electrode layer 130 is, for example, about 20 vol % or less.

The first inner electrode layer 120 and the second inner electrode layer 130 each have any thickness but may each have a thickness of, for example, about 0.3 μm or more and 1.0 μm or less. Although the number of the first inner electrode layers 120 and the number of the second inner electrode layers 130 are each any number, the total number of both may be, for example, about 10 layers or more and 150 layers or less.

In the multilayer ceramic capacitor 1, electrostatic capacitance is generated by positioning the first inner electrode layer 120 and the second inner electrode layer 130 opposite to each other with the dielectric layer 110 interposed therebetween. The multiple first inner electrode portions are mutually spaced while being opposite to the same second inner electrode layer 130, thus being able to achieve a high-capacitance-density multilayer ceramic capacitor in which multiple capacitor function portions are arranged side by side densely.

As FIGS. 3 to 6 illustrate, the multiple first via conductors 140 are provided inside the capacitor main body 100 and are electrically connected to the multiple first inner electrode layers 120. The multiple first via conductors 140 are inserted in the second through holes 130h formed in each of the multiple second inner electrode layers 130 and are insulated from the multiple second inner electrode layers 130. In the present example embodiment, the multiple first via conductors 140 are arranged in multiple lines.

As FIGS. 3 and 5 illustrate, each of the multiple first inner electrode portions is electrically connected to corresponding multiple first via conductors 140 of the multiple first via conductors 140. In the present example embodiment, the first inner electrode portion 121 is electrically connected to corresponding three first via conductors 140 that are arranged in a line. The first inner electrode portion 122 is electrically connected to corresponding another three first via conductors 140 that are arranged in a line.

Each of the multiple first via conductors 140 is provided inside the capacitor main body 100 so as to extend in the lamination direction from the first main surface 101 toward the second main surface 102 of the capacitor main body 100. That is, each of the multiple first via conductors 140 is exposed at the first main surface 101 of the capacitor main body 100 and not exposed at the second main surface 102. Thus, a short circuit between an electronic component disposed on the second main surface 102 side and the multilayer ceramic capacitor 1 can be prevented from occurring.

As FIGS. 3 to 6 illustrate, the multiple second via conductors 150 are provided inside the capacitor main body 100 and are electrically connected to the multiple second inner electrode layers 130. The multiple second via conductors 150 are inserted in the first through holes 120h formed in each of the multiple first inner electrode layers 120 and are insulated from the multiple first inner electrode layers 120. In the present example embodiment, the multiple second via conductors 150 are arranged in a line between the lines in which the multiple first via conductors 140 are arranged. The first via conductors 140 and the second via conductors 150 are arranged in a matrix. The second inner electrode layer 130 is electrically connected to three second via conductors 150 arranged in a line.

Each of the multiple second via conductors 150 is provided inside the capacitor main body 100 so as to extend in the lamination direction from the first main surface 101 toward the second main surface 102 of the capacitor main body 100. That is, each of the multiple second via conductors 150 is exposed at the first main surface 101 of the capacitor main body 100 and not exposed at the second main surface 102.

By arranging the multiple first via conductors 140 in a line and the multiple second via conductors 150 in a line alternately as described above, magnetic fields induced by the current flowing through the first via conductor 140 and the current flowing through the second via conductor 150 cancel each other, thus being able to lower the equivalent series inductance (ESL) of the multilayer ceramic capacitor 1.

The first via conductor 140 and the second via conductor 150 each have any shape and may each have, for example, a circular columnar shape. The diameters of the first via conductor 140 and the second via conductor 150 in that case may be, for example, about 30 μm or more and about 150 μm or less. In addition, the distance between the first via conductor 140 and the second via conductor 150 that are adjacent to each other, more specifically, the distance between the center of the first via conductor 140 and the center of the second via conductor 150 is, for example, about 50 μm or more and about 500 μm or less.

The materials of the first via conductor 140 and the second via conductor 150 are each any material and may be, for example, a metal such as Ni, Cu, Ag, Pd, Pt, Fe, Ti, Cr, Sn, or Au or an alloy including such an above-described metal.

As FIGS. 1 to 3 illustrate, the multiple first outer electrodes 20 and the at least one second outer electrode 30 are mutually spaced on the first main surface 101. In the present example embodiment, the first outer electrodes 20 include a first outer electrode 21 and a first outer electrode 22. However, the number of the first outer electrodes 20 is not limited to two and may be three or more. In the present example embodiment, the number of the second outer electrodes 30 is one but may be two or more.

Each of the multiple first outer electrodes 20 extends in a rectangular shape. However, the shapes of the multiple first outer electrodes 20 are not each limited to such a rectangular shape and may each be, for example, a trapezoidal shape, an L shape, a U shape, an X shape, or a T shape.

Each of the multiple first outer electrode 20 is electrically connected to corresponding multiple first via conductors 140 electrically connected to a corresponding first inner electrode portion of the multiple first inner electrode portions. In the present example embodiment, the first outer electrode 21 is electrically connected to corresponding three first via conductors 140 electrically connected to the corresponding first inner electrode portion 121. The first outer electrode 22 is electrically connected to corresponding three first via conductors 140 electrically connected to the corresponding first inner electrode portion 122. However, the connection relationship between the first outer electrode 20 and the first via conductor 140 is not limited to the above and may be any relationship as long as corresponding multiple first via conductors 140 electrically connected to a corresponding first inner electrode portion are connected to each first outer electrode 20.

The at least one second outer electrode 30 extends in a rectangular shape. However, the shape of the second outer electrode 30 is not limited to such a rectangular shape and may be, for example, a trapezoidal shape, an L shape, a U shape, an X shape, or a T shape.

The at least one second outer electrode 30 is electrically connected to corresponding multiple second via conductors 150 of the multiple second via conductors 150. In the present example embodiment, one second outer electrode 30 is electrically connected to all the three second via conductors 150. However, the connection relationship between the second outer electrode 30 and the second via conductor 150 is not limited to the above and may be any relationship as long as corresponding multiple second via conductors 150 are connected to each second outer electrode 30.

The materials of the first outer electrode 20 and the second outer electrode 30 are each any material. In the present example embodiment, the first outer electrode 20 and the second outer electrode 30 are each a plated electrode formed by plating treatment by using a rotary plating method. Examples of the material of the plated electrode include Cu, Ni, and Sn. The plated electrode may be provided by a single layer or by multiple layers.

In the multilayer ceramic capacitor 1 according to the first example embodiment of the present invention, each of the multiple first inner electrode layers 120 includes the first inner electrode portion 121 and the first inner electrode portion 122 mutually separated in the same layer. Each of the multiple second inner electrode layers 130 is defined by one body in the same layer. Each of the first inner electrode portion 121 and the first inner electrode portion 122 is electrically connected to the corresponding multiple first via conductors 140 of the multiple first via conductors 140. Each of the first outer electrode 21 and the first outer electrode 22 is electrically connected to the multiple first via conductors 140 electrically connected to a corresponding first inner electrode portion of the first inner electrode portion 121 and the first inner electrode portion 122. The at least one second outer electrode 30 is electrically connected to the corresponding multiple second via conductors 150 of the multiple second via conductors 150.

Thus, by connecting the first outer electrode 21 and the first outer electrode 22 to respective power sources different in electric potential while grounding the second outer electrode 30, a capacitor function portion provided by the first inner electrode portion 121 and the second inner electrode layer 130 that are opposite to each other across the dielectric layer 110 and another capacitor function portion provided by the first inner electrode portion 122 and the second inner electrode layer 130 that are opposite to each other across the dielectric layer 110 can be arranged side by side densely, thus being able to achieve the high-capacitance-density multilayer ceramic capacitor 1.

In addition, each first outer electrode 20 is electrically connected to multiple first via conductors 140, and each second outer electrode 30 is electrically connected to multiple second via conductors 150, thus being able to facilitate the connection of each of the first outer electrode 20 and the second outer electrode 30 to a connecting terminal of, for example, an IC and to achieve the shortest distance connection therebetween, compared with when each of the first via conductor 140 and the second via conductor 150 is connected to a connecting terminal of, for example, an IC on a one-to-one basis. In particular, an example embodiment of the present invention is effective when the pitch of connecting terminals of, for example, an IC, is short.

In the multilayer ceramic capacitor 1 according to the first example embodiment of the present invention, the multiple first via conductors 140 are arranged in multiple lines. The multiple second via conductors 150 are arranged in a line between the lines in which the multiple first via conductors 140 are arranged, thus being able to lower the ESL of the multilayer ceramic capacitor 1.

In the multilayer ceramic capacitor 1 according to the first example embodiment of the present invention, the second outer electrode 30 is disposed between the first outer electrodes 20, thus being able to facilitate visual discrimination between the first outer electrode 20 and the second outer electrode 30 regardless of the orientation of the multilayer ceramic capacitor 1. The orientation of the multilayer ceramic capacitor 1 here refers to a vertical orientation and a horizontal orientation, for example, when the state illustrated in FIG. 2 is defined as the vertical orientation, and the state in which the multilayer ceramic capacitor 1 in FIG. 2 is rotated by 90 degrees is defined as the horizontal orientation.

Hereinafter, modification examples of the multilayer ceramic capacitor according to the first example embodiment of the present invention will be described. In the description of the following modification examples, elements, portions, features, etc., similar to those of the multilayer ceramic capacitor according to the first example embodiment of the present invention are denoted by the same reference signs, and the description thereof will not be repeated.

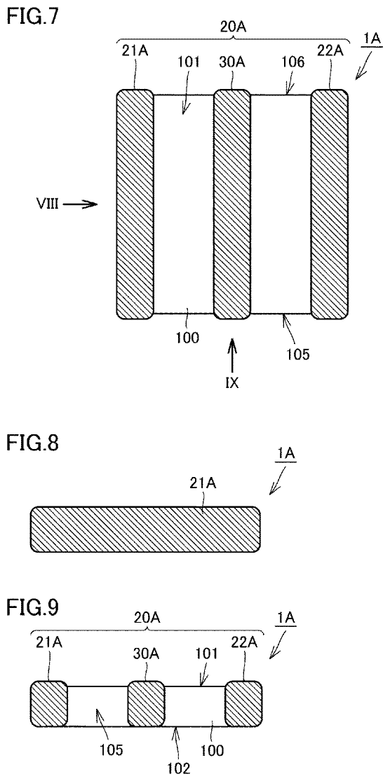

FIG. 7 is a plan view of a multilayer ceramic capacitor according to a first modification example of the first example embodiment of the present invention. FIG. 8 is a side view of the multilayer ceramic capacitor in FIG. 7 when viewed in the VIII arrow direction. FIG. 9 is a side view of the multilayer ceramic capacitor in FIG. 7 when viewed in the IX arrow direction.

As FIGS. 7 to 9 illustrate, a multilayer ceramic capacitor 1A according to the first modification example of the first example embodiment of the present invention includes multiple first outer electrodes 20A and at least one second outer electrode 30A. The first outer electrodes 20A include a first outer electrode 21A and a first outer electrode 22A. Each of the multiple first outer electrodes 20A extends on a first main surface 101 and onto at least one side surface of the four side surfaces. The at least one second outer electrode 30A extends on the first main surface 101 and onto at least one side surface of the four side surfaces.

In the present modification example, the first outer electrode 21A is provided on the first main surface 101 and extends onto a first side surface 103, a third side surface 105, and a fourth side surface 106. The first outer electrode 21A covers a ridge portion between the first main surface 101 and the first side surface 103. The first outer electrode 22A is provided on the first main surface 101 and extends onto a second side surface 104, the third side surface 105, and the fourth side surface 106. The first outer electrode 22A covers a ridge portion between the first main surface 101 and the second side surface 104. The second outer electrode 30A is provided on the first main surface 101 and extends onto the third side surface 105 and the fourth side surface 106.

In the present modification example, since a corner portion or a ridge portion of a capacitor main body 100 can be covered by using the first outer electrodes 20A and the second outer electrode 30A, a corner portion or a ridge portion of the capacitor main body 100 can be prevented from being broken or chipped. In addition, the electrical characteristics of the multilayer ceramic capacitor 1A can be measured by bringing a probe into contact with each of the first outer electrode 20A and the second outer electrode 30A on the side surfaces of the capacitor main body 100.

In the present modification example, the first outer electrode 20A and the second outer electrode 30A may be formed by, for example, a sputtering method, a vapor deposition method, or a method in which metal powder or metal powder paste is baked.

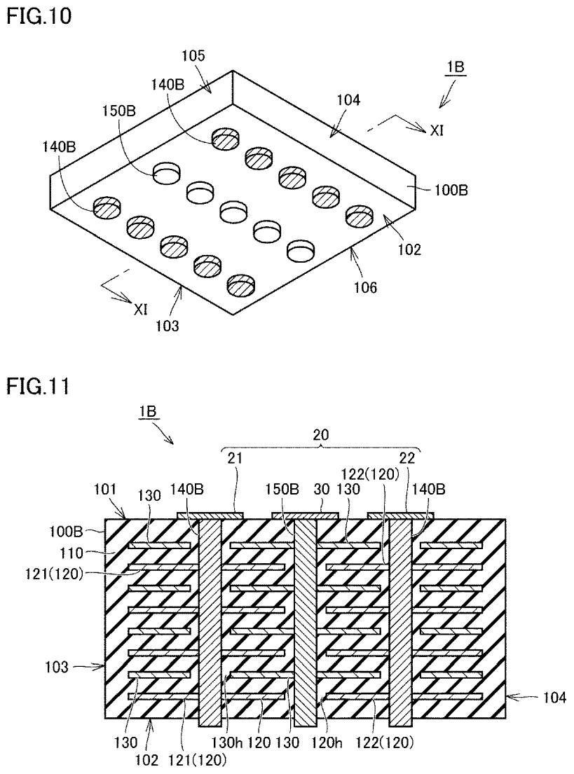

FIG. 10 is a perspective view of a multilayer ceramic capacitor according to a second modification example of the first example embodiment of the present invention when viewed from the second main surface side. FIG. 11 is a sectional view of the multilayer ceramic capacitor in FIG. 10 when viewed from the direction of XI-XI line arrows.

As FIGS. 10 and 11 illustrate, a multilayer ceramic capacitor 1B according to the second modification example of the first example embodiment of the present invention includes multiple first via conductors 140B and multiple second via conductors 150B that are provided inside a capacitor main body 100B. The first via conductors 140B and the second via conductors 150B are arranged in a matrix.

Each of the multiple first via conductors 140B is exposed at a first main surface 101 of the capacitor main body 100B and also exposed at a second main surface 102. Specifically, each of the multiple first via conductors 140B extends through the capacitor main body 100B in the lamination direction. In each of the multiple first via conductors 140B, in the lamination direction, one end is connected to a first outer electrode 20, and the other end protrudes from the second main surface 102. Note that the other end of each of the multiple first via conductors 140B does not necessarily protrude from the second main surface 102 and may be positioned flush with the second main surface 102.

Each of the multiple second via conductors 150B is exposed at the first main surface 101 of the capacitor main body 100B and also exposed at the second main surface 102. Specifically, each of the multiple second via conductors 150B extends through the capacitor main body 100B in the lamination direction. In each of the multiple second via conductors 150B, in the lamination direction, one end is connected to a second outer electrode 30, and the other end protrudes from the second main surface 102. Note that the other end of each of the multiple second via conductors 150B does not necessarily protrude from the second main surface 102 and may be positioned flush with the second main surface 102.

As described above, in the present modification example, the multiple first via conductors 140B and the multiple second via conductors 150B are each exposed on the second main surface 102 side. Thus, an electronic component connected to the first main surface 101 side and an electronic component connected to the second main surface 102 side can be electrically connected with the multilayer ceramic capacitor 1B interposed therebetween.

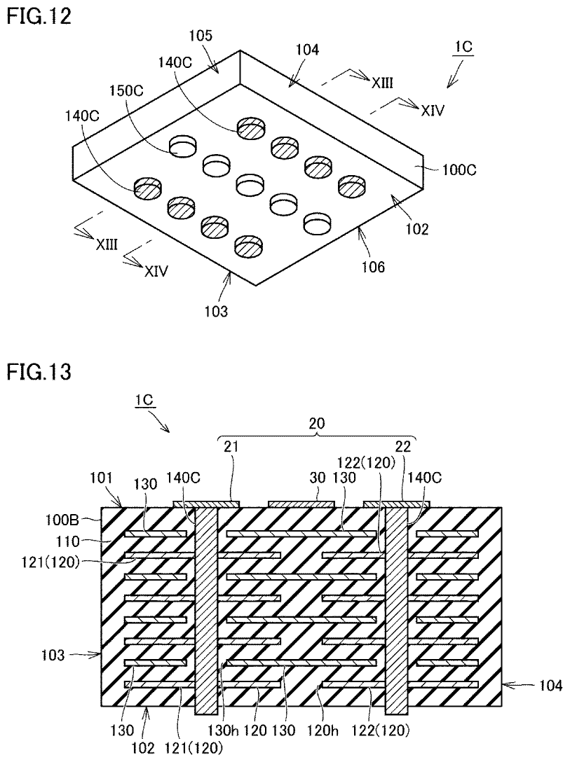

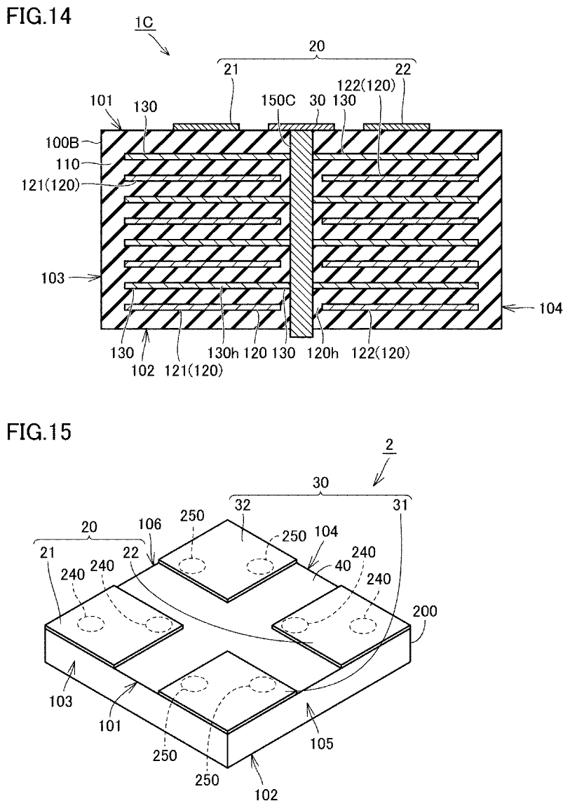

FIG. 12 is a perspective view of a multilayer ceramic capacitor according to a third modification example of the first example embodiment of the present invention when viewed from the second main surface side. FIG. 13 is a sectional view of the multilayer ceramic capacitor in FIG. 12 when viewed from the direction of XIII-XIII line arrows. FIG. 14 is a sectional view of the multilayer ceramic capacitor in FIG. 12 when viewed from the direction of XIV-XIV line arrows.

As FIGS. 12 to 14 illustrate, a multilayer ceramic capacitor 1C according to the third modification example of the first example embodiment of the present invention includes multiple first via conductors 140C and multiple second via conductors 150C that are provided inside a capacitor main body 100C. The first via conductor 140C and the second via conductor 150C are located at different positions in a column direction. In the present modification example, as with the second modification example, the multiple first via conductors 140C and the multiple second via conductors 150C are also each exposed on the second main surface 102 side. Thus, an electronic component connected to the first main surface 101 side and an electronic component connected to the second main surface 102 side can be electrically connected with the multilayer ceramic capacitor 1C interposed therebetween.

### Second Example Embodiment

Hereinafter, a multilayer ceramic capacitor according to the second example embodiment of the present invention will be described with reference to the drawings. Since the multilayer ceramic capacitor according to the second example embodiment of the present invention differs from the multilayer ceramic capacitor according to the first example embodiment of the present invention mainly in the layout of a first outer electrode, a second outer electrode, a first via conductor, and a second via conductor and in further provision of an insulating layer, constituents similar to those of the multilayer ceramic capacitor according to the first example embodiment of the present invention are denoted by the same reference signs, and the description thereof will not be repeated.

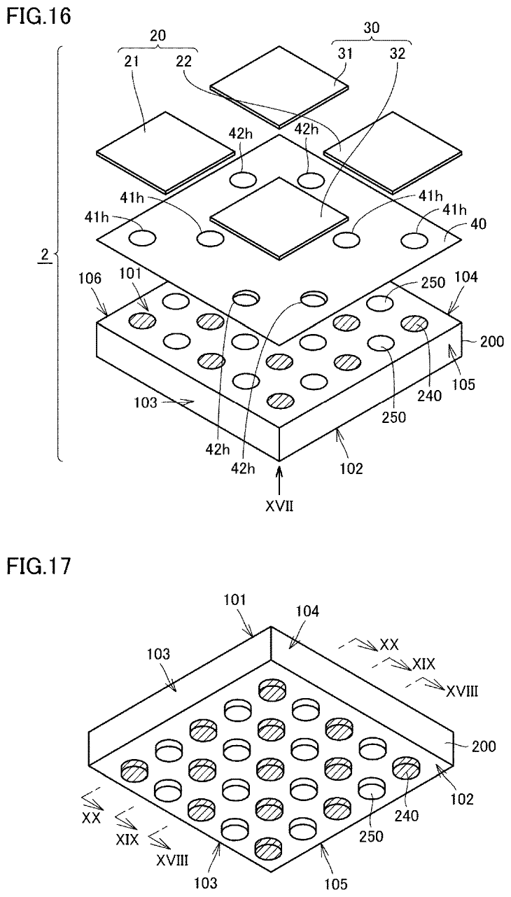

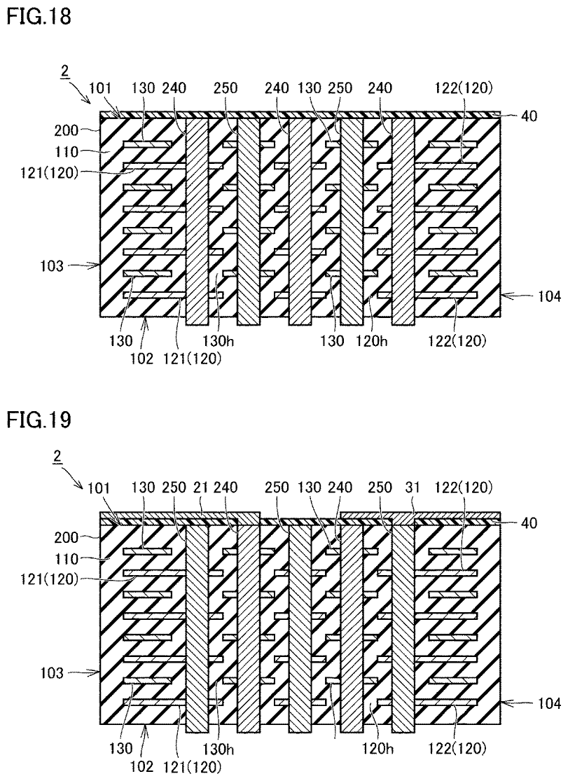

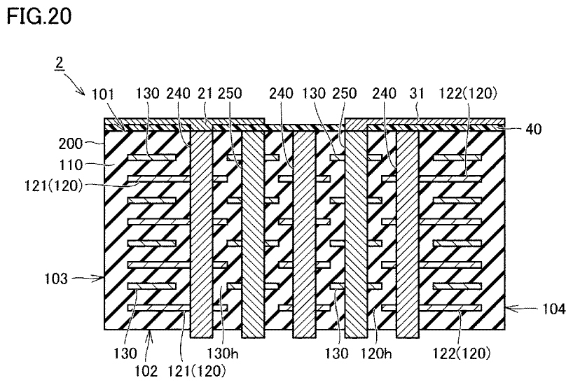

FIG. 15 is a perspective view of the multilayer ceramic capacitor according to the second example embodiment of the present invention when viewed from the first main surface side. FIG. 16 is an exploded perspective view illustrating the configuration of the multilayer ceramic capacitor according to the second example embodiment of the present invention. FIG. 17 is a perspective view of the multilayer ceramic capacitor in FIG. 16 when viewed in the XVII direction. FIG. 18 is a sectional view of the multilayer ceramic capacitor in FIG. 17 when viewed from the direction of XVIII-XVIII line arrows. FIG. 19 is a sectional view of the multilayer ceramic capacitor in FIG. 17 when viewed from the direction of XIX-XIX line arrows. FIG. 20 is a sectional view of the multilayer ceramic capacitor in FIG. 17 when viewed from the direction of XX-XX line arrows.

As FIGS. 15 to 20 illustrate, a multilayer ceramic capacitor 2 according to the second example embodiment of the present invention includes a capacitor main body 200, multiple first via conductors 240, multiple second via conductors 250, multiple first outer electrodes 20, multiple second outer electrodes 30, and an insulating layer 40.

As FIGS. 16 to 20 illustrate, the multilayer ceramic capacitor 2 according to the second example embodiment of the present invention includes the multiple first via conductors 240 and the multiple second via conductors 250 that are provided inside the capacitor main body 200. The multiple first via conductors 240 and the multiple second via conductors 250 are arranged alternately in each of a row direction and the column direction.

Each of the multiple first via conductors 240 is exposed at a first main surface 101 of the capacitor main body 200 and also exposed at a second main surface 102. Specifically, each of the multiple first via conductors 240 extends through the capacitor main body 200 in the lamination direction. In each of the multiple first via conductors 240, in the lamination direction, one end is positioned flush with the first main surface 101, and the other end protrudes from the second main surface 102. Note that the other end of each of the multiple first via conductors 240 does not necessarily protrude from the second main surface 102 and may be positioned flush with the second main surface 102.

Each of the multiple second via conductors 250 is exposed at the first main surface 101 of the capacitor main body 200 and also exposed at the second main surface 102. Specifically, each of the multiple second via conductors 250 extends through the capacitor main body 200 in the lamination direction. In each of the multiple second via conductors 250, in the lamination direction, one end is positioned flush with the first main surface 101, and the other end protrudes from the second main surface 102. Note that the other end of each of the multiple second via conductors 250 does not necessarily protrude from the second main surface 102 and may be positioned flush with the second main surface 102.

The insulating layer 40 is provided on the first main surface 101. The insulating layer 40 covers the entire first main surface 101. The insulating layer 40 includes multiple first cavities 41h and multiple second cavities 42h.

The insulating layer 40 may be made of a ceramic. When the insulating layer 40 is made of a ceramic, the material of the insulating layer 40 may be Al₂O₃, PZT, SiC, SiO₂, or MgO. When the insulating layer 40 is made of a ceramic, the mechanical strength of the multilayer ceramic capacitor 2 against stress can be improved. In addition, when the insulating layer 40 is made of a ceramic, in comparison between the grain size of the ceramic included in a dielectric layer 110 and the grain size of the ceramic included in the insulating layer 40, the grain size of the ceramic included in the insulating layer 40 is preferably smaller.

When the insulating layer 40 is made of a ceramic, a method for forming the insulating layer 40 may be, for example, an aerosol deposition method (AD method), a thermal spraying method such as a cold spraying method, or CVD (chemical vapor deposition).

In addition, when the insulating layer 40 is made of a resin, the material of the insulating layer 40 may include an epoxy resin, a silicone resin, a fluororesin, a phenol resin, a urea resin, a melamine resin, an unsaturated polyester resin, barium titanate, alumina, silica, yttria, or zirconia. In this case, as the material of the insulating layer 40, for example, a thermosetting epoxy resin using metal oxide to be used as a solder resist, a silicone resin, a fluororesin, a phenol resin, a melamine resin, barium titanate, alumina, or silica is preferably used.

When the insulating layer 40 is made of a resin, the insulating layer 40 may be formed by using, for example, a spraying apparatus or a dipping apparatus to form the insulating layer 40. Alternatively, the insulating layer 40 may be stuck on the first main surface 101 of the capacitor main body 200, or the insulating layer 40 may be formed by a screen printing method.

Depending on the physical properties of such an above-described insulating material, the insulating layer 40 is adhered and fixed to the first main surface 101 of the multilayer ceramic capacitor 2 by, for example, being thermally set or dried.

As FIGS. 15 and 16 illustrate, the multiple first outer electrodes 20 and the multiple second outer electrodes 30 are mutually spaced on the insulating layer 40. In the present example embodiment, the first outer electrodes 20 include a first outer electrode 21 and a first outer electrode 22. However, the number of the first outer electrodes 20 is not limited to two and may be three or more. The first outer electrode 21 and the first outer electrode 22 each have a rectangular shape and are positioned above respective corner portions, in the rectangular first main surface 101, positioned on one diagonal line. In the present example embodiment, the second outer electrodes 30 include a second outer electrode 31 and a second outer electrode 32. However, the number of the second outer electrodes 30 is not limited to two and may be any number greater than or equal to one. The second outer electrode 31 and the second outer electrode 32 each have a rectangular shape and are positioned above respective corner portions, in the rectangular first main surface 101, positioned on the other diagonal line.

In the present example embodiment, each of the first outer electrode 21 and the first outer electrode 22 covers corresponding two first via conductors 240 of the multiple first via conductors 240 and corresponding two second via conductors 250 of the multiple second via conductors 250. However, the number of the first via conductors 240 covered with each of the first outer electrode 21 and the first outer electrode 22 is not limited to two and may be three or more. The number of the second via conductors 250 covered with each of the first outer electrode 21 and the first outer electrode 22 is not limited to two and may be any number greater than or equal to one.

In the present example embodiment, each of the second outer electrode 31 and the second outer electrode 32 covers corresponding two first via conductors 240 of the multiple first via conductors 240 and corresponding two second via conductors 250 of the multiple second via conductors 250. However, the number of the first via conductors 240 covered with each of the second outer electrode 31 and the second outer electrode 32 is not limited to two and may be any number greater than or equal to one. The number of the second via conductors 250 covered with each of the second outer electrode 31 and the second outer electrode 32 is not limited to two and may be three or more.

Each of the first outer electrode 21 and the first outer electrode 22 is electrically connected to the corresponding two first via conductors 240 through corresponding two first cavities 41h of the multiple cavities. Specifically, a portion of each of the first outer electrode 21 and the first outer electrode 22 is provided inside the first cavity 41h and connected to one end, in the lamination direction, of the first via conductor 240.

As FIGS. 19 and 20 illustrate, the first outer electrode 21 is electrically connected to the two first via conductors 240 electrically connected to a corresponding first inner electrode portion 121. Similarly, the first outer electrode 22 is electrically connected to the two first via conductors 240 electrically connected to a corresponding first inner electrode portion 122. However, the connection relationship between the first outer electrode 20 and the first via conductor 240 is not limited to the above and may be any relationship as long as multiple first via conductors 240 electrically connected to a corresponding first inner electrode portion are connected to each first outer electrode 20.

As FIGS. 15, 16, 19, and 20 illustrate, each of the second outer electrode 31 and the second outer electrode 32 is electrically connected to the corresponding two second via conductors 250 through corresponding two second cavities 42h of the multiple cavities. Specifically, a portion of each of the second outer electrode 31 and the second outer electrode 32 is provided inside the second cavity 42h and connected to one end, in the lamination direction, of the second via conductor 250. However, the connection relationship between the second outer electrode 30 and the second via conductor 250 is not limited to the above and may be any relationship as long as corresponding multiple second via conductors 250 are connected to each second outer electrode 30.

In the multilayer ceramic capacitor 2 according to the second example embodiment of the present invention, the multiple first via conductors 240 and the multiple second via conductors 250 are arranged alternately in each of the row direction and the column direction. Thus, the ESL of the multilayer ceramic capacitor 2 can be made even lower than the multilayer ceramic capacitor 1 according to the first example embodiment.

In the multilayer ceramic capacitor 2 according to the second example embodiment of the present invention, the multiple first outer electrodes 20 are each electrically connected to the corresponding multiple first via conductors 240 through the corresponding first cavities 41h of the multiple cavities. At least one second outer electrode 30 is electrically connected to the corresponding multiple second via conductors 250 through the corresponding second cavities 42h of the multiple cavities. Thus, it is possible to ensure flexibility in the layout of the first outer electrodes 20 and the second outer electrode 30 while reducing or preventing the influence of the layout of the first via conductors 240 and the second via conductors 250. That is, while maintaining the layout of the first via conductors 240 and the second via conductors 250 and disposing the first outer electrodes 20 and the second outer electrode 30 at any positions, the first outer electrode 20 and the first via conductors 240 corresponding to the first outer electrode 20 can be electrically connected, and the second outer electrode 30 and the second via conductors 250 corresponding to the second outer electrode 30 can be electrically connected. Further, while using the general-purpose capacitor main body 200, the flexibility in the layout of the first outer electrodes 20 and the second outer electrode 30 can be ensured.

In the description of the above-described example embodiments, combinable configurations may be mutually combined.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a capacitor main body including multiple first inner electrode layers and multiple second inner electrode layers that are alternately laminated one by one across a dielectric layer in a lamination direction, the capacitor main body including a first main surface and a second main surface positioned opposite from the first main surface in the lamination direction;
multiple first via conductors inside the capacitor main body and electrically connected to the multiple first inner electrode layers;
multiple second via conductors inside the capacitor main body and electrically connected to the multiple second inner electrode layers; and
multiple first outer electrodes and at least one second outer electrode mutually spaced on the first main surface; wherein
each of the multiple first inner electrode layers includes multiple first inner electrode portions mutually separated in a same layer;
each of the multiple second inner electrode layers is defined by one body in a same layer;
each of the multiple first inner electrode portions is electrically connected to corresponding multiple first via conductors of the multiple first via conductors;
each of the multiple first outer electrodes is electrically connected to multiple first via conductors electrically connected to a corresponding first inner electrode portion of the multiple first inner electrode portions; and
the at least one second outer electrode is electrically connected to corresponding multiple second via conductors of the multiple second via conductors.

2. The multilayer ceramic capacitor according to claim 1, wherein
the capacitor main body includes four side surfaces connecting the first main surface and the second main surface;
each of the multiple first outer electrodes extends on the first main surface and onto at least one side surface of the four side surfaces; and
the at least one second outer electrode extends on the first main surface and onto at least one side surface of the four side surfaces.

3. The multilayer ceramic capacitor according to claim 1, wherein the multiple first via conductors and the multiple second via conductors are each exposed on the second main surface side.

4. The multilayer ceramic capacitor according to claim 1, wherein
the multiple first via conductors are arranged in multiple lines; and
the multiple second via conductors are arranged in a line between the lines in which the multiple first via conductors are arranged.

5. The multilayer ceramic capacitor according to claim 1, wherein the multiple first via conductors and the multiple second via conductors are arranged alternately in each of a row direction and a column direction.

6. The multilayer ceramic capacitor according to claim 1, further comprising an insulating layer on the first main surface and including multiple cavities.

7. The multilayer ceramic capacitor according to claim 6, wherein the multiple first outer electrodes and the at least one second outer electrode are mutually spaced on the insulating layer.

8. The multilayer ceramic capacitor according to claim 1, wherein the capacitor main body includes at least one rounded corner portion or at least one ridge portion.

9. The multilayer ceramic capacitor according to claim 1, wherein the capacitor main body has a rectangular or substantially rectangular shape and has dimensions of about 0.3 mm or more and about 3.0 mm or less in a vertical direction, about 0.3 mm or more and about 3.0 mm or less in a lateral direction, and about 50 μm or more and about 200 μm or less in a lamination direction.

10. The multilayer ceramic capacitor according to claim 1, wherein each of the multiple first via conductors is exposed at the first main surface of the capacitor main body but not exposed at the second main surface of the capacitor main body.

11. The multilayer ceramic capacitor according to claim 1, wherein each of the multiple second via conductors is exposed at the first main surface of the capacitor main body but not exposed at the second main surface of the capacitor main body.

12. The multilayer ceramic capacitor according to claim 1, wherein a diameter of each of the multiple first via conductors and the multiple second via conductors is about 30 μm or more and about 150 μm or less.

13. The multilayer ceramic capacitor according to claim 1, wherein a distance between a center of one of the multiple first via conductors and a center of one of the multiple second via conductors is about 50 μm or more and about 500 μm or less.

14. The multilayer ceramic capacitor according to claim 8, wherein the at least one first outer electrode covers the at least one ridge portion.

15. The multilayer ceramic capacitor according to claim 8, wherein the multiple outer electrodes includes two first outer electrodes covering a respective one of the at least one ridge portion.

16. The multilayer ceramic capacitor according to claim 1, wherein each of the multiple first via conductors is exposed at each of the first main surface and the second main surface of the capacitor main body.

17. The multilayer ceramic capacitor according to claim 1, wherein each of the multiple second via conductors is exposed at each of the first main surface and the second main surface of the capacitor main body.

18. The multilayer ceramic capacitor according to claim 1, wherein, for each of the multiple first via conductors, a first end is flush with the first main surface and a second end protrudes from the second main surface, or the first end is flush with the first main surface and the second end is flush with the second main surface.

19. The multilayer ceramic capacitor according to claim 1, wherein, for each of the multiple second via conductors, a first end is flush with the first main surface and a second end protrudes from the second main surface, or the first end is flush with the first main surface and the second end is flush with the second main surface.

20. The multilayer ceramic capacitor according to claim 6, wherein the insulating layer includes a ceramic or a resin.
